(19) United States
(12) Patent Application Publication
(10) Pub. No.: US 2004/0088266 A1
(43) Pub. Date: May 6, 2004

(54) Postage payment cards

(76) Inventors: Daniel L. Briley, Escondido, CA (US); Susan M.F. Davis, Nampa, ID (US); Donald B. Ouchida, Corvallis, OR (US); Clay C. Higgins, Corvallis, OR (US); Robert Sesek, Meridian, ID (US)

Correspondence Address: HEWLETT-PACKARD COMPANY, Intellectual Property Administration, P. O. Box 272400, Fort Collins, CO, 80527-2400, US

(21) Appl. No.: 10/284,816

(22) Filed: Oct. 31, 2002

(51) Int. Cl. G06F 17/00; G07B 17/02

(52) U.S. Cl. 705/401; 705/408

(57) ABSTRACT

A system for paying for a postage amount for an item includes a card interface and a processing system. The card interface receives account information for an account from a postage payment card and transfers the account information to a processing system. The processing system determines the postage amount for the item. The processing system then generates and transmits a charge instruction to charge the postage amount to the account based on the account information. The processing system also generates and transmits a print instruction to print postage indicia on the item.

### BACKGROUND OF THE INVENTION

1. Field of the Invention

The invention is related to the field of mailing systems, and in particular, to a system, method, and software for postage payment cards.

2. Statement of the Problem

Businesses use postage meters to print postage indicia on items to conveniently avoid trips to the local post office. In the United States, businesses lease these mailing systems from mailing system manufacturers and purchase the postage from the local USPS office to load into their postage meter. These postage meters monitor usage by decrementing from this prepaid amount of postage. The postage meters print the evidence of postage that provide information such as mailing date, amount of postage, licensing post office city, licensing post office state, meter manufacturer, and meter number. The mailing system determines the postage amount based on the weight and size of the package and the type or class of service, such as express, priority, first class mail, etc. The postage amount decrements the postage amount from the prepaid amount of postage in the postage meter. Once the prepaid amount of postage is depleted, the user must go to the local post office to replenish the amount in the postage meter.

One problem is that the postage meters can be bulky and awkward, so trips to the local post office for postage meter replenishment are inconvenient. Another problem is that each postage meter must be uniquely interfaced to a specific mailing system. Thus, a user is tied to a specific installation or physical setup and has no mobility to use other mailing systems with the same account.

Other industries, such as the telecommunications industry, have used prepaid cards for payment of goods or services. In the telecommunications industry, prepaid phone cards are used for payment of calls. In the prepaid phone card service, a caller obtains a prepaid account with an amount such as a monetary amount or a period of time that is decremented when a call is made. Retail stores also offer prepaid gift cards that are decremented when the consumer makes a purchase. However, no such payment cards have been used for payment of postage.

### SUMMARY OF THE SOLUTION

Embodiments of the invention helps to solve the above problems with methods, systems, and software products that use postage payment cards to pay for a postage amount on an item. Embodiments of the invention advantageously saves people from periodically carrying a postage meter to the local post office. Embodiments of the invention also advantageously provides a user mobility to utilize any mailing system that accepts the postage payment cards.

A system for paying for a postage amount on an item includes a card interface and a processing system. The card interface receives account information for an account from a postage payment card and transfers the account information to a processing system. The processing system determines the postage amount on the item. The processing system then generates and transmits a charge instruction to charge the postage amount to the account based on the account information. The processing system also generates and transmits a print instruction to print postage indicia on the item.

In one embodiment, the card interface updates the account information on the postage payment card based on the charge instruction. In another embodiment, the card interface encrypts the account information on the postage payment card. In another embodiment, the card interface reads the account information on a magnetic strip on the postage payment card. In another embodiment, the card interface reads the account information on a bar code on the postage payment card.

### DESCRIPTION OF THE DRAWINGS

The same reference number represents the same element on all drawings.

FIG. 1 is a block diagram for a system for postage payment cards in an example of the invention.

FIG. 2 is a block diagram of the processing system in an example of the invention.

FIG. 3 is a flow chart for a system for postage payment cards in an example of the invention.

FIG. 4 is a block diagram of a system for postage payment cards with a card account system in an example of the invention.

FIG. 5 is a message sequence chart for the system for the postage payment cards with a card account system in an example of the invention.

### DETAILED DESCRIPTION OF THE INVENTION

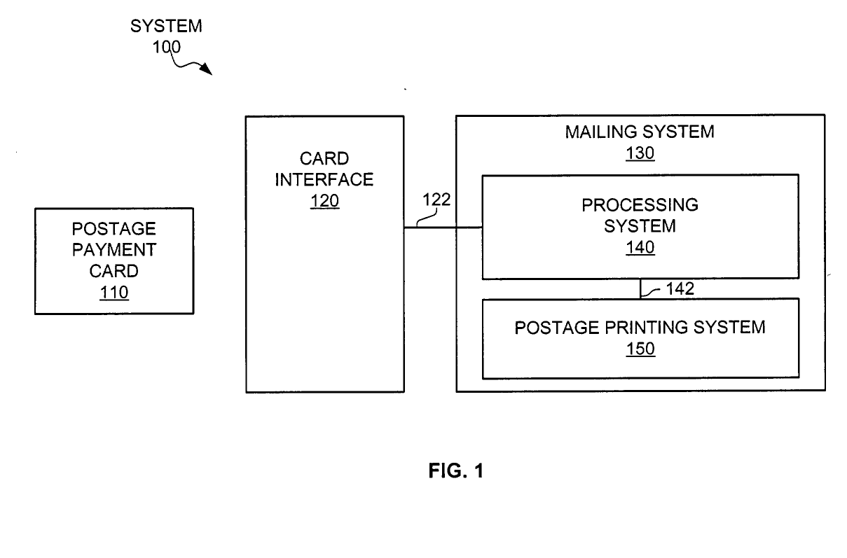

FIGS. 1-5 and the following description depict specific examples to teach those skilled in the art how to make and use the best mode of the invention. For the purpose of teaching inventive principles, some conventional aspects have been simplified or omitted. Those skilled in the art will appreciate variations from these examples that fall within the scope of the invention. Those skilled in the art will appreciate that the features described below can be combined in various ways to form multiple variations of the invention. As a result, the invention is not limited to the specific examples described below, but only by the claims and their equivalents.

### System for Postage Payment Cards—FIGS. 1-3

FIG. 1 depicts a block diagram for a system 100 for postage payment cards 110 in an example of the invention. The system 100 includes a postage payment card 110, a card interface 120, and a mailing system 130. The mailing system 130 includes a processing system 140 and a postage printing system 150. In some embodiments, the mailing system 130 includes the card interface 120. The card interface 120 is connected to the processing system 140 via a link 122. The processing system 140 is connected to the postage printing system 150 via a link 142.

The postage payment card 110 includes any card that contains account information for an account used for paying postage amounts. One example of a postage payment card 110 is a pre-pay postage payment card that contains a prepaid amount that is decremented when a user prints postage. A postage amount includes the amount charged for mailing an item.

Account information includes any information related to an account used for paying postage amounts. In some embodiments, the account information is encoded on a magnetic stripe on the postage payment card 110. In other embodiments, the account information is encoded on a bar code on the postage payment card 110. Some examples of account information are the account number and the amount remaining on the card.

In some embodiments, the amount remaining is currency, units, credits, or number of uses. In some embodiments, a kiosk or computer system updates the account information on the postage payment card. Also, in some embodiments, the account information is encrypted on the postage payment card 110.

The card interface 120 includes any interface, device, or system configured to receive account information for an account from a postage payment card and transfer the account information to a processing system 140. In some embodiments, the card interface 120 includes a magnetic strip reader. In other embodiments, the card interface includes a bar code reader. In some embodiments, the card interface 120 is configured to update account information on the postage payment card 110.

The processing system 140 includes any system, device, or group of devices configured to (1) determine the postage amount for the item, (2) generate and transmit a charge instruction to adjust the postage amount to the account based on the account information, and (3) generate and transmit a print instruction to print postage indicia on the item. The charge instruction includes any instruction, message, or signal that indicates to charge the postage amount to an account. Charging an account includes debiting or posting an amount against an account.

The print instruction includes any instruction, message, or signal that indicates to print postage indicia on an item. Postage indicia include any marking, stamp, or writing that indicates a payment for delivery. One example of providing postage indicia in the US is printing with a red fluorescent ink and provides information such as mailing date, amount of postage, licensing post office city, licensing post office state, meter manufacturer, and meter number. The postage printing system 150 includes any system, device, or group of devices configured to receive a print instruction and print postage indicia on an item based on the print instruction.

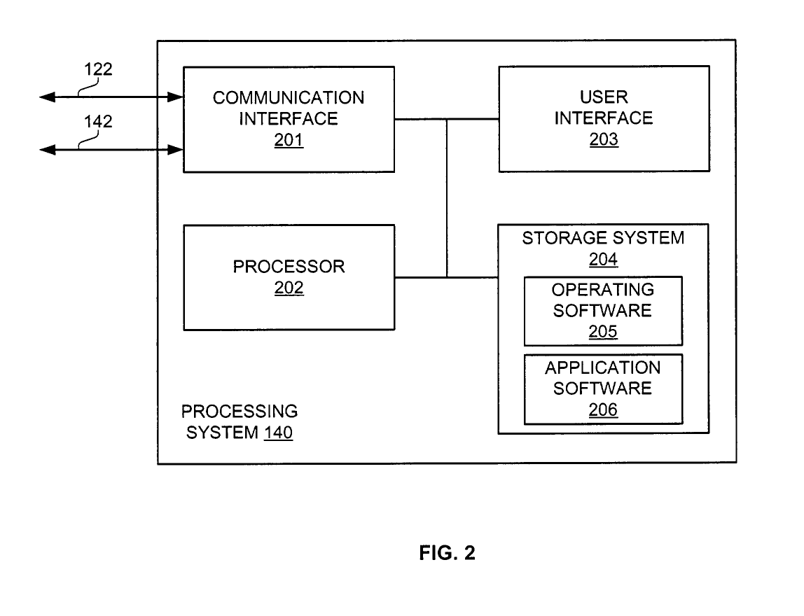

FIG. 2 depicts a block diagram of the processing system 140 in an example of the invention. The processing system 140 includes communication interface 201, processor 202, user interface 203, and storage system 204. Storage system 204 stores operating software 205 and application software 206. Processor 202 is linked to communication interface 201, user interface 203, and storage system 204. Communication interface 201 links processing system 140 to card interface 120 and postage printing system 150 via links 122 and 142, respectively.

Processing system 140 could be comprised of a programmed general-purpose computer, although those skilled in the art will appreciate that programmable or special purpose circuitry and equipment may be used. Processing system 140 may use a client server architecture where operations are distributed among a server system and client devices that together comprise elements 201-206.

Communication interface 201 could comprise a network interface card, modem, port, or some other communication device. Communication interface 201 may be distributed among multiple communication devices. Processor 202 could comprise a computer microprocessor, logic circuit, or some other processing device. Processor 202 may be distributed among multiple processing devices.

User interface 203 could comprise a keyboard, mouse, voice recognition interface, microphone and speakers, graphical display, touch screen, or some other type of user device.

Storage system 204 could comprise a disk, tape, integrated circuit, server, or some other memory device. Storage system 204 may be distributed among multiple memory devices.

Processor 202 retrieves and executes operating software 205 and application software 206 from storage system 204. Operating software 205 may comprise an operating system, utilities, drivers, networking software, and other software typically loaded onto a general-purpose computer.

Application software 206 could comprise an application program, firmware, or some other form of machine-readable processing instructions. When executed by processor 202, application software 206 directs processor 202 to operate in accord with the invention.

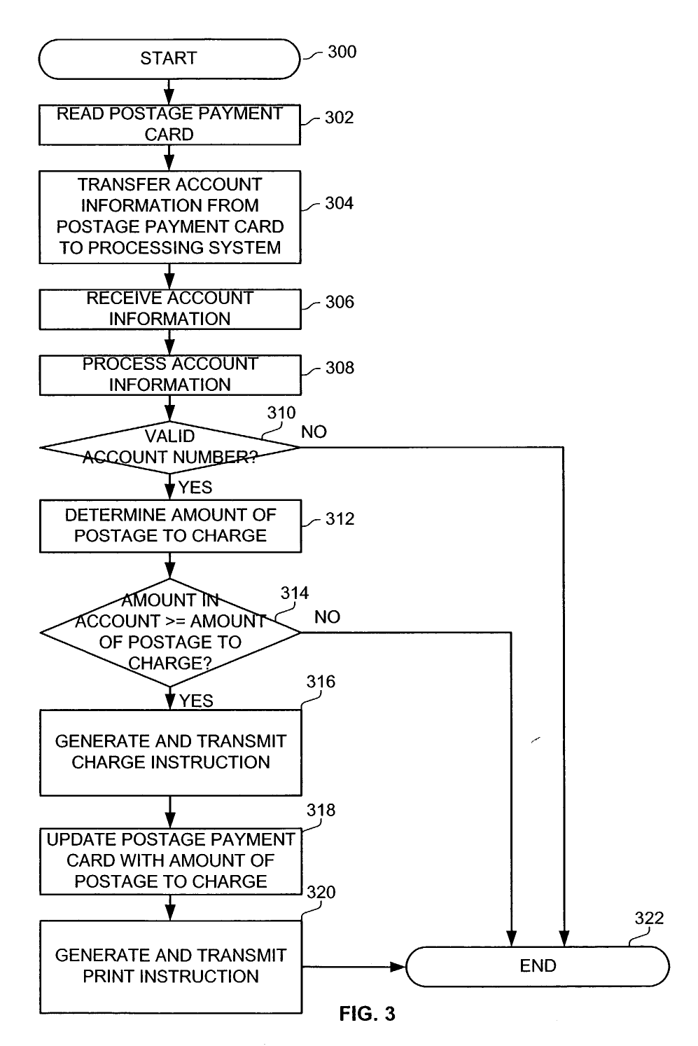

FIG. 3 depicts a flow chart for the system 100 for postage payment cards in an example of the invention. In this example, the postage payment card 110 is a prepaid postage payment card where the user pays for a postage amount that is stored on the postage payment card. FIG. 3 begins in step 300. In step 302, the card interface 120 reads the postage payment card 110 for account information.

The card interface 120 then transfers the account information from the postage payment card 110 to the processing system 140 in step 304.

The processing system 140 then receives the account information in step 306.

The processing system 140 then processes the account information in step 308.

In step 310, the processing system 140 checks if the account number is valid. In one embodiment, the processing system 140 stores a list of valid account numbers to validate against. In another embodiment, the processing system 140 queries an account database to validate the account number.

If the account number is determined to be invalid, then the processing system 140 ends at step 322. In one embodiment, the processing system 140 displays a message indicating an invalid account number. An account number may be invalid for a variety of reasons, including but not limited to a lack of funds, etc.

If the account number is valid, then the processing system 140 determines the amount of postage to charge in step 312. In one embodiment, the processing system 140 determines the amount of postage to charge based on a weight and class of service of the item from the postage printing system 150 and a list of rates to charge for weight ranges and classes of services.

In step 314, the processing system 140 then determines whether the amount of postage to charge is greater than the amount remaining in the account.

If the amount of postage to charge is greater than the amount remaining in the account, the processing system 140 ends in step 322. In one embodiment, the processing system 140 displays a message indicating the amount remaining in the account is insufficient for the amount of postage to be charged.

If the amount remaining in the account is greater than or equal to the amount of postage to charge, then the processing system 140 generates a charge instruction to update the postage payment card 110 with the amount of postage to charge in step 316. The processing system 140 then transmits the update instruction to the card interface 120.

The card interface 120 then updates the postage payment card 110 by decrementing the remaining amount in the account by the amount of postage to charge in step 318. In one embodiment, the card interface 120 encrypts the account information on the postage payment card 110.

In step 320, the processing system 140 generates and transmits a print instruction to the postage printing system 150 to print the postage indicia on the item. The processing system 140 then ends in step 322.

One advantage is a business or user does not have to periodically carry the postage meter, or other components from inside the postage meter to the local post office. The postage payment cards are smaller and easier to replenish funds into. Another advantage is the postage payment cards provide a user with the ability to use any mailing system that accepts the postage payment cards. Also, the user may use a wide variety of systems with their postage payment cards.

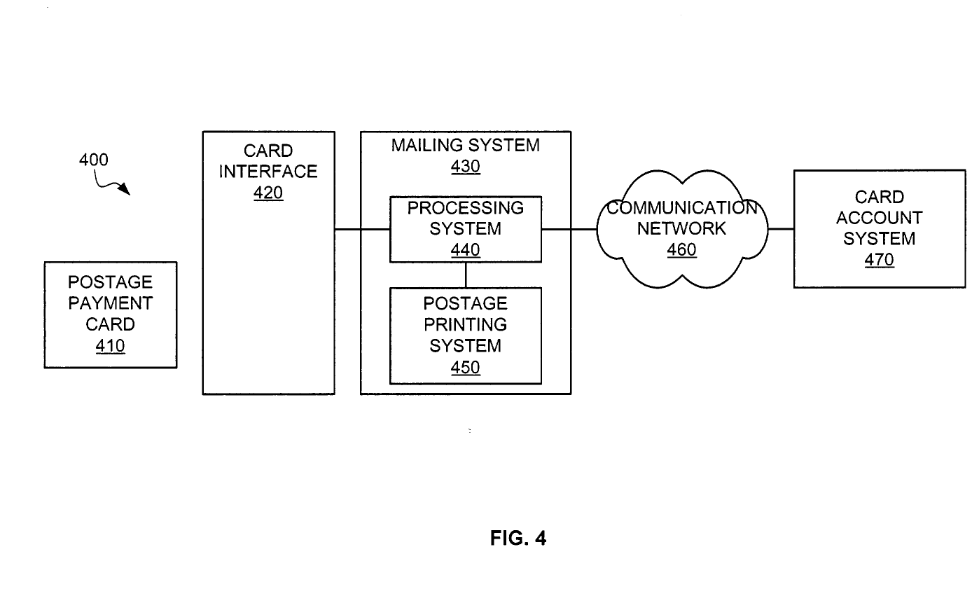

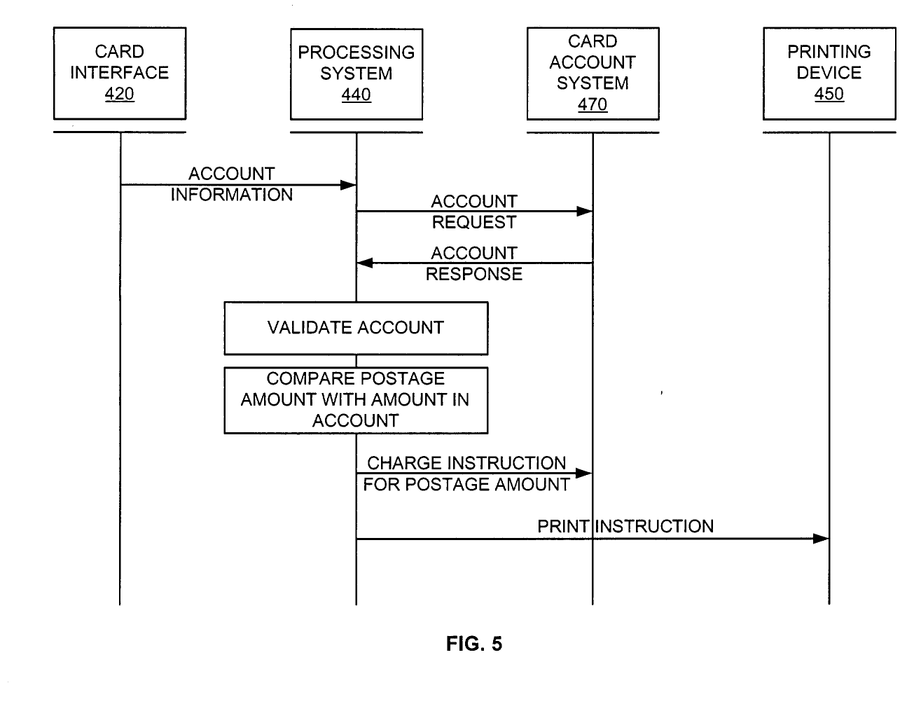

### System for Postage Payment Cards with Card Account System—FIGS. 4-5

FIG. 4 depicts a block diagram of a system 400 for postage payment cards 410 with a card account system 470 in an example of the invention. The system 400 for postage payment cards 410 includes a postage payment card 410, a card interface 420, a mailing system 430, a communication network 460, and the card account system 470. The mailing system 430 comprises the processing system 440 and the postage printing system 450. The card interface 420 is connected to the processing system 440. The processing system 440 is connected to the postage printing system 450 and the communication network 460. The communication network 460 is connected to the card account system 470.

The communication network 460 could be any network or connections. Some examples of the communication network 460 are a local area network (LAN), a wide area network (WAN), and the Internet. The card account system 470 is any system, device, or group of devices configured to maintain account information for the postage payment cards 410. In some embodiments, the card account system 470 stores the account information such as the account numbers, the amounts remaining in the accounts, and billing information.

FIG. 5 depicts a message sequence chart for the system 400 for the postage payment cards 410 in an example of the invention. After reading the postage payment card 410, the card interface 420 transfers the account information from the postage payment card 410 to the processing system 440. The processing system 440 then generates and transmits an account request to the card account system 470 based on the account information. The account request is to receive additional account information stored in the card account system 470. In this embodiment, the account number is stored on the postage payment card, and the processing system 440 uses the account number to retrieve the amount remaining on the account from the card account system 470. The processing system 440 then receives an account response from the card account system 470.

The processing system 440 then validates the account number from the postage payment card 410 based on the account response. The processing system 440 then compares the amount for the postage charge and the remaining amount in the account. If the remaining amount in the account is greater than or equal to the amount for the postage charge, the processing system 440 generates and transmits a charge instruction to the card account system 470 to decrement the remaining amount in the account by the amount for the postage charge. The processing system 440 also generates and transmits a print instruction to the postage printing system 450 to authorize printing of the postage indicia on the item.

The above-described elements can be comprised of instructions that are stored on storage media. The instructions can be retrieved and executed by a processor. Some examples of instructions are software, program code, and firmware. Some examples of storage media are memory devices, tape, disks, integrated circuits, and servers. The instructions are operational when executed by the processor to direct the processor to operate in accord with the invention. Those skilled in the art are familiar with instructions, processor, and storage media.

1. A method of paying for a postage amount for an item, the method comprising:
receiving account information for an account from a postage payment card;
determining the postage amount for the item;
generating a charge instruction to charge the postage amount to the account based on the account information;
transmitting the charge instruction;
generating a print instruction to print postage indicia on the item; and
transmitting the print instruction.

2. The method of claim 1 further comprising updating the account information on the postage payment card based on the charge instruction.

3. The method of claim 1 further comprising encrypting the account information on the postage payment card.

4. The method of claim 2 further comprising decrypting the account information on the postage payment card.

5. The method of claim 1 further comprising updating the account information in a card account system based on the charge instruction.

6. The method of claim 1 wherein receiving the account information for the account from the postage payment card comprises reading the account information on a magnetic strip on the postage payment card.

7. The method of claim 1 wherein receiving the account information for the account from the postage payment card comprises reading the account information on a bar code on the postage payment card.

8. The method of claim 1 wherein generating and transmitting the charge instruction to charge the postage amount to the account based on the account information comprises decrementing the postage amount from an amount remaining for the account.

9. The method of claim 1 further comprising printing the postage indicia on the item based on the print instruction.

10. A system for paying for a postage amount for an item, the system comprising:
a card interface configured to receive account information for an account from a postage payment card and transfer the account information; and
a processing system connected to the card interface and configured to determine the postage amount for the item, generate and transmit a charge instruction to charge the postage amount to the account based on the account information, and generate and transmit a print instruction to print postage indicia on the item.

11. The system of claim 10 wherein the card interface is configured to update the account information on the postage payment card based on the charge instruction.

12. The system of claim 10 wherein the card interface is configured to encrypt the account information on the postage payment card.

13. The system of claim 12 wherein the card interface is configured to decrypt the account information on the postage payment card.

14. The system of claim 10 further comprising a card account system configured to update the account information based on the charge instruction.

15. The system of claim 10 wherein the card interface is configured to read the account information on a magnetic strip on the postage payment card.

16. The system of claim 10 wherein the card interface is configured to read the account information on a bar code on the postage payment card.

17. The system of claim 10 wherein the processing system is configured to decrement s the postage amount from an amount remaining for the account.

18. The system of claim 10 further comprising a postage printing system configured to print the postage indicia on the item based on the print instruction.

19. A software product for paying for a postage amount for an item, the software product comprising:
application software operational when executed by a processing system to direct the processing system to receive account information for an account from a postage payment card from a card interface, determine the postage amount for the item, generate and transmit a charge instruction to charge the postage amount to the account based on the account information, and generate and transmit a print instruction to print postage indicia on the item; and
a software storage medium operational to store the application software.

20. The software product of claim 18 wherein the application software is operational when executed by the processing system to direct the processing system to decrement the postage amount from an amount remaining for the account.

21. A system for paying for a postage amount for an item, the system comprising:
a first means for receiving account information for an account from a postage payment card and transfer the account information; and
a second means for determining the postage amount for the item, generating and transmitting a charge instruction to charge the postage amount to the account based on the account information, and generating and transmitting a print instruction to print postage indicia on the item.

22. The system of claim 21 wherein the first means is for updating the account information on the postage payment card based on the charge instruction.

23. The system of claim 21 wherein the first means is for encrypting the account information on the postage payment card.

24. The system of claim 23 wherein the first means is for decrypting the account information on the postage payment card.

25. The system of claim 21 further comprising a third means for updating the account information based on the charge instruction.

26. The system of claim 21 wherein the first means is for reading the account information on a magnetic strip on the postage payment card.

27. The system of claim 21 wherein the first means is for reading the account information on a bar code on the postage payment card.

28. The system of claim 21 wherein the second means is for decrementing the postage amount from an amount remaining for the account.

29. The system of claim 21 further comprising a third means for printing the postage indicia on the item based on the print instruction.

30. A processing system for paying for a postage amount for an item, the processing system comprising:
a storage system configured to store application software operational when executed by a processor to direct the processor to receive account information for an account from a postage payment card from a card interface, determine the postage amount for the item, generate and transmit a charge instruction to charge the postage amount to the account based on the account information, and generate and transmit a print instruction to print postage indicia on the item; and
the processor connected to the storage system.

31. The processing system of claim 30 wherein the application software is operational when executed by the processor to direct the processor to decrement the postage amount from an amount remaining for the account.
